(19) United States
(12) Patent Application Publication
(10) Pub. No.: US 2005/0264933 A1
(43) Pub. Date: Dec. 1, 2005

(54) Magnetic recording head with reduced thermally induced protrusion

(76) Inventors: Ning Shi, San Jose, CA (US); Xiao Wu, San Jose, CA (US); Hong Zhang, Fremont, CA (US)

Correspondence Address: WAGNER, MURABITO & HAO LLP, Third Floor, Two North Market Street, San Jose, CA, 95113, US

(21) Appl. No.: 10/857,586

(22) Filed: May 28, 2004

(51) Int. Cl. G11B 5/147

(52) U.S. Cl. 360/126

(57) ABSTRACT

A magnetic recording head with reduced thermally induced protrusion. In one embodiment, a thermal expansion constraining layer comprising silicon dioxide for instance overlays a magnetic recording head. The thermal expansion constraining layer has a very low coefficient of thermal expansion. A sealant layer comprising aluminum oxide overlays the thermal expansion constraining layer. The thermal expansion constraining layer prevents deleterious deformation of underlying head structures that can degrade performance of a storage system. The sealant layer protects the thermal expansion constraining layer from propagation of surface defects therein by protection from shock, including shock during fabrication, as well as moisture, increasing manufacturing yield and reliability.

### FIELD OF THE INVENTION

Embodiments in accordance with the present invention relate to the field of data storage devices. More specifically, embodiments in accordance with the present invention relate to magnetic recording heads.

### BACKGROUND

A disk storage system, such as a magnetic hard disk drive (HDD), uses one or more disks or “platters” as a data recording medium. The HDD records data on the disk by use of a magnetic recording head which can also reproduce data from the disk.

The recording or read/write heads of modern hard disk drives do not actually make contact with the recording media. Rather the heads “fly” on a cushion of air generated by the relative motion of the head over a rapidly spinning platter or disk comprising the recording media. The “face” of the recording head adjacent to the disk is known as the air bearing surface, or ABS. The ability of a head to fly at a desirable height is a critical performance aspect of hard disk drives.

Increased levels of storage capacity in hard disk drives are the result of many improvements in a variety of areas, including, for example, finer head positioning, smaller track width and smaller head flying height. Decreases in track width and head flying height produce beneficial increases in aerial storage density. For example, it is generally desirable to fly a head closer to a recording media in order to write a more precise or “finer” magnetic pattern and/or to detect weaker magnetic signals previously recorded onto such media. Additionally, it is desirable that the head maintain the same media/head clearance or flying height during both read (playback) and write (record) operations.

As head flying height decreases, the shape of the head becomes ever more important. It is to be appreciated that the surface of a head is similar to an airfoil. For example, heads in a hard disk drive are often forced toward a recording surface by their support mechanism while aerodynamic lift from airflow “over” the head opposes such force, keeping the head from making contact with the recording surface. More particularly, and in conjunction with other aspects of miniaturization, the ability of a flying recording head to maintain a particular shape under a variety of operating conditions contributes to maintaining a beneficial flying height and is highly desirable.

Unfortunately, in many modern head assemblies, thermal expansion due to heating resulting from a write current can cause a highly undesirable change in shape of the recording head. Such shape changes can enlarge the head and/or disrupt airflow over the head. Such shape changes will generally cause undesirable changes in head flying height. For example, if the head flys too high as a result of such a shape change, a write operation performed at such time may write too wide a track, damaging adjacent stored information. Additionally, too high a flying height may result in weakly recorded signals.

By way of further example, flying too low, e.g., too close to a recording media is also undesirable. Flying below a desirable height can cause overly strong recorded signals. Additionally, heads that are flying too low may not be able to clear, e.g., fly over, small particles, e.g., dust, that are present within the head disk enclosure, potentially causing damage to the head and/or media. An additional ever-present danger of heads flying too low is that the head can “crash” onto the media surface. Such a head crash can severely damage both head and media, leading to a catastrophic loss of stored data.

A conventional art approach to mitigate such thermal expansion is to replace a standard head coating material, e.g., aluminum oxide (Al₂O₃), with silicon dioxide (SiO₂). Silicon dioxide has a coefficient of thermal expansion (CTE) of approximately one order of magnitude lower than the coefficient of thermal expansion for aluminum oxide. During writing operations of a hard disk drive, silicon dioxide expands less than aluminum oxide, greatly reducing deformation of the read/write head.

Unfortunately, silicon dioxide has a lower fracture toughness than aluminum oxide, e.g., SiO₂ cracks more easily than Al₂O₃, and moisture in known to embrittle silicon dioxide. As a deleterious consequence, silicon dioxide coatings over heads are damaged during processing at an undesirably high rate. FIG. 1 (conventional art) illustrates several types of damage commonly observed when processing head structures comprising silicon dioxide. For example, surface defects in the form of micro-cracks can form on the surface creating by cutting. Such micro-cracks can take the form of edge cracks and surface cracks. These surface micro-cracks generally bisect into edge cracks when intersected by a cutting blade. Water-based cleaning during processing tends to make such coatings more brittle and encourage more cracking, as well as propagating existing cracks.

### SUMMARY OF THE INVENTION

Therefore, improvements to a magnetic recording head to increase its resistance to thermally induced protrusion are highly desired.

Accordingly, a novel magnetic recording head with reduced thermally induced protrusion is disclosed. In one embodiment, a thermal expansion constraining layer comprising silicon dioxide for instance overlays a magnetic recording head. The thermal expansion constraining layer has a very low coefficient of thermal expansion. A sealant layer comprising aluminum oxide overlays the thermal expansion constraining layer. The thermal expansion constraining layer prevents deleterious deformation of underlying head structures that can degrade performance of a storage system. The sealant layer protects the thermal expansion constraining layer from propagation of surface defects therein by protection from shock, including shock during fabrication, as well as moisture, increasing manufacturing yield and reliability.

In accordance with other embodiments of the present invention, a magnetic recording head is coated with multiple alternating layers of expansion constraining layers and sealant layers. A sealant layer comprises the outermost layer in one embodiment.

In accordance with embodiments of the present invention, a sealant layer serves to prevent surface defects of a thermal expansion constraining layer from exposure to water and/or moisture, e.g., due to cleaning operations during fabrication. Reduced water/moisture exposure serves to prevent thermal expansion constraining layer fracture toughness degradation, and to provide reduced stress intensity factor from a constraining effect of a sealant layer, which will reduce driving forces for crack propagation. Both characteristics serve to increase chip and crack resistance during fabrication. To further increase fracture resistance and constraint to thermal protrusion, a multilayer laminate may be utilized to maximize such benefits.

### BRIEF DESCRIPTION OF THE DRAWINGS

FIG. 1 (conventional art) illustrates several types of damage commonly observed when processing head structures comprising silicon dioxide.

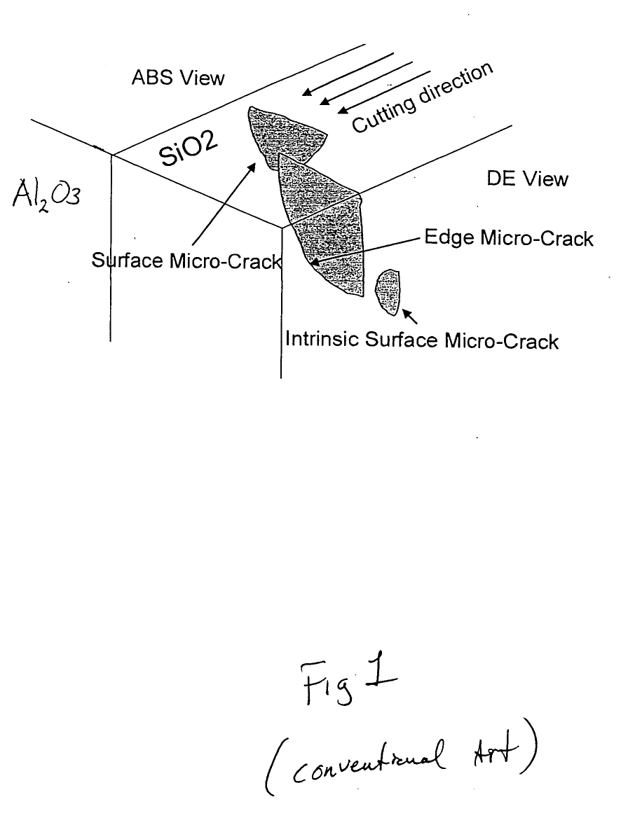

FIG. 2 illustrates a portion of a magnetic recording head, in accordance with embodiments of the present invention.

FIG. 3 illustrates a portion of a magnetic recording head comprising multiple alternating layers of a thermal expansion constraining layer and a sealant layer, in accordance with other embodiments of the present invention.

FIG. 4 illustrates a method of manufacturing a magnetic recording head, in accordance with embodiments of the present invention.

### DETAILED DESCRIPTION OF THE INVENTION

In the following detailed description of the present invention, magnetic recording head with reduced thermally induced protrusion, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

### Magnetic Recording Head with Reduced Thermally Induced Protrusion

Embodiments in accordance with the present invention relate to the field of data storage devices. More specifically, embodiments in accordance with the present invention relate to magnetic recording heads, e.g., for use in data storage disk drive systems. It is to be appreciated, however, that embodiments in accordance with the present invention are well suited to other areas.

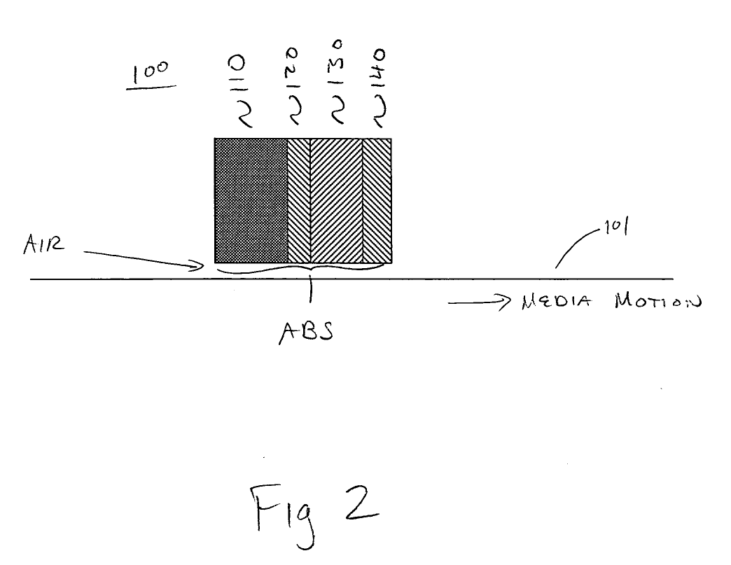

FIG. 2 illustrates a portion of a magnetic recording head 100 or “slider,” in accordance with embodiments of the present invention. For orientation purposes, surface 101 is a recording media, for example a platter of a hard disk drive. Surface 101 is moving (rotating) left to right relative to magnetic recording head 100, inducing airflow around magnetic recording head 100. For example, layer 140 of magnetic recording head 100 is the aerodynamic trailing edge of magnetic recording head 100. The slider surface adjacent to the magnetic media is known as an “air bearing surface,” or ABS. It is appreciated that most such magnetic recording heads will also comprise a thin carbon or silicon nitrate film (not shown) on the surface facing the recording media.

Layer 110 of magnetic recording head 100 comprises various metals and hard bake resist, and comprises the magnetic recording coil. Such materials are characterized by having greater coefficients of thermal expansion than ceramic materials. Unfortunately, such materials can also be characterized as brittle, and suffer a susceptibility to moisture damage, which can create crack tip residual stress, aiding crack propagation.

Layer 120 is a first head overcoat layer comprising aluminum oxide. Aluminum oxide is widely used throughout the disk drive industry as a first head overcoat layer. As discussed previously, a write current within magnetic recording head 100 can cause heating of layers 110 and 120. Such heating can cause deleterious deformations of an aluminum oxide layer utilized as the first head overcoat layer of a magnetic recording head. Such deformations can result in unreliable operation and/or damage of a hard disk drive.

As discussed previously, silicon dioxide has been proposed in the conventional art as a thermal expansion constraining layer, e.g., applied over aluminum oxide layer 120 to mitigate such deformations. Layer 130 is such a thermal expansion constraining layer of silicon dioxide. Silicon dioxide has a coefficient of thermal expansion that is about an order of magnitude smaller than that of aluminum oxide. Unfortunately, while serving to mitigate heat-induced deformations of an underlying overcoat layer of aluminum oxide layer, silicon dioxide suffers from several less desirable characteristics, including, for example, brittleness and a susceptibility to moisture damage.

In accordance with embodiments of the present invention, sealant layer 140 comprising aluminum oxide is deposited over thermal expansion constraining layer 130. Sealant layer 140 protects thermal expansion constraining layer 130 from moisture and many shock events that might cause cracking in thermal expansion constraining layer 130. Additionally, sealant layer 140 serves to limit the propagation of any cracks that do form in layer 130.

In accordance with other embodiments of the present invention, materials other than silicon dioxide can be utilized as a thermal expansion constraining layer, for example Al₂O₃ doped SiO₂ (3%) and boron nitride (BN) with basal plane parallel to layer interface. Such a thermal expansion constraining layer should have a coefficient of thermal expansion that is less than a coefficient of thermal expansion for a layer that is to be constrained, e.g., a thermal expansion constraining layer should have a coefficient of thermal expansion that is less than a coefficient of thermal expansion for a first head overcoat layer.

In accordance with still other embodiments of the present invention, materials other than aluminum oxide can be utilized as a sealant layer over a thermal expansion constraining layer. Such sealant layers should resist shock damage and chemicals utilized during processing, e.g., water. In general, suitable sealant layer materials can be characterized as having a high fracture toughness. For example, suitable sealant layer materials are not easily cracked and do not propagate cracks if formed. Suitable sealant layer materials should have a fracture toughness at least as good as Al₂O₃, for example molybdenum disilicide (MoSi₂) and some forms of Si₃N₄. A low permeability for moisture penetration is also highly desirable.

Such a sealant layer serves to prevent surface defects of a thermal expansion constraining layer from exposure to water and/or moisture, e.g., due to cleaning operations during fabrication. Reduced water/moisture exposure serves to prevent thermal expansion constraining layer fracture toughness degradation, and to provide reduced stress intensity factor from at the crack tip from effects such as external mechanical disturbance during fabrication and/or from a constraining stresses of its own sealant layer, which will reduce driving forces for crack propagation. Both characteristics serve to increase chip and crack resistance during fabrication. To further increase fracture resistance and constraint to thermal protrusion, a multilayer laminate may be utilized to maximize such benefits.

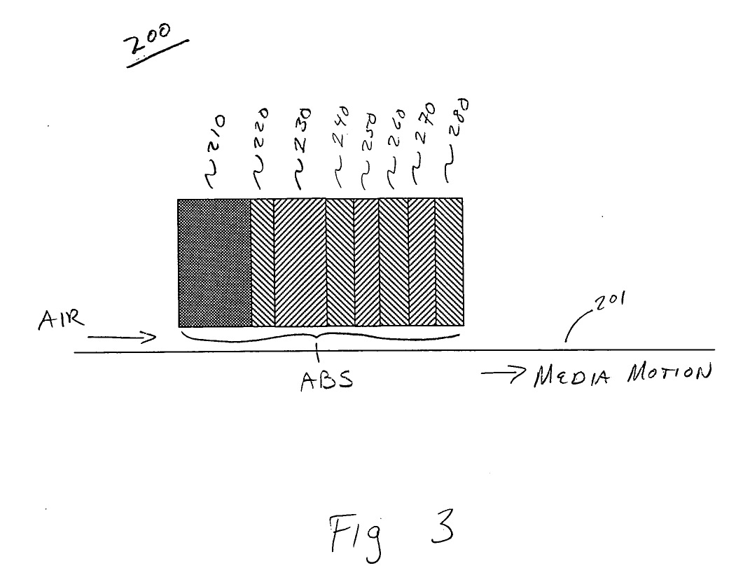

FIG. 3 illustrates a portion of a magnetic recording head 200, in accordance with embodiments of the present invention. For orientation purposes, surface 201 is a recording media, for example a platter of a hard disk drive. Surface 201 is moving (rotating) left to right relative to magnetic recording head 200, inducing airflow around magnetic recording head 200. For example, layer 280 of magnetic recording head 100 is the aerodynamic trailing edge of magnetic recording head 200. The slider surface adjacent to the magnetic media is known as an “air bearing surface,” or ABS. It is appreciated that most such magnetic recording heads will also comprise a thin carbon or silicon nitrate film (not shown) on the surface facing the recording media.

Layer 210 of magnetic recording head 200 comprises various metals and hard bake resist and comprises the magnetic recording coil. Such materials are characterized by having greater coefficients of thermal expansion than ceramic materials. Unfortunately, such materials can also be characterized as brittle, and suffer a susceptibility to moisture damage, which can create crack tip residual stress, aiding crack propagation.

Layers 220, 230 and 240 of FIG. 3 correspond to layers 120, 130 and 140 of FIG. 2. More particularly, layer 230 is a thermal expansion constraining layer comprising silicon dioxide while layers 220 and 240 comprise aluminum oxide. As will be further described below, layers 220, 230 and 240 are generally, although not necessarily, thinner than corresponding layers 120, 130 and 140 of FIG. 2.

Magnetic recording head 200 further comprises additional thermal expansion constraining layers 250 and 270 comprising silicon dioxide alternating with sealant layers 260 and 280 of aluminum oxide. Although two additional sets of a thermal expansion constraining layer in conjunction with a sealant layer, e.g., a set comprising layers 250 and 260 and a set comprising layers 270 and 280, are depicted in FIG. 3, it is to be appreciated that embodiments in accordance with the present invention are well suited to a wide range of numbers of such sets of alternating layers.

The ability of a combination of a thermal expansion constraining layers in conjunction with sealant layers to constrain thermal expansion is a function of volume fraction ration as well as individual laminate thickness. This is illustrated for the present exemplary materials (SiO₂ and Al₂O₃) in Relation 1, below:

$$Δ Protrusion = \frac{τ t}{{G}_{A12O3}} ln ( 1 / {V}_{SiO2} ) \qquad Relation 1$$

Where t is the SiO₂ individual layer thickness, G is the shear modulus (of Al₂O₃) and V is the volume fraction of SiO₂.

The quantity τ is approximated by Relation 2, below:

$$τ \approx ΔαΔ {TE}_{SiO2} \sqrt{\frac{{G}_{A1203}}{2 {E}_{SiO2} ln ( 1 / {V}_{SiO2} )}} \qquad Relation 2$$

Where E is the tensile modulus (of SiO₂), T is the thermal expansion difference between SiO₂ and Al₂O₃, and V is the volume fraction of SiO₂.

The constraining efficiency is linearly related to SiO₂ thickness (t), if all other parameters are kept constant. Consequently, as long as the same volume/thickness ratio of SiO₂/Al₂O₃ is maintained, increasing the number of sets of layers increases the constraining efficiency as well as lowers the stress intensity factor. It is to be appreciated that there is a minimum inter-layer thickness below which a crack in SiO₂ will “tunnel” and/or break Al₂O₃ ligament.

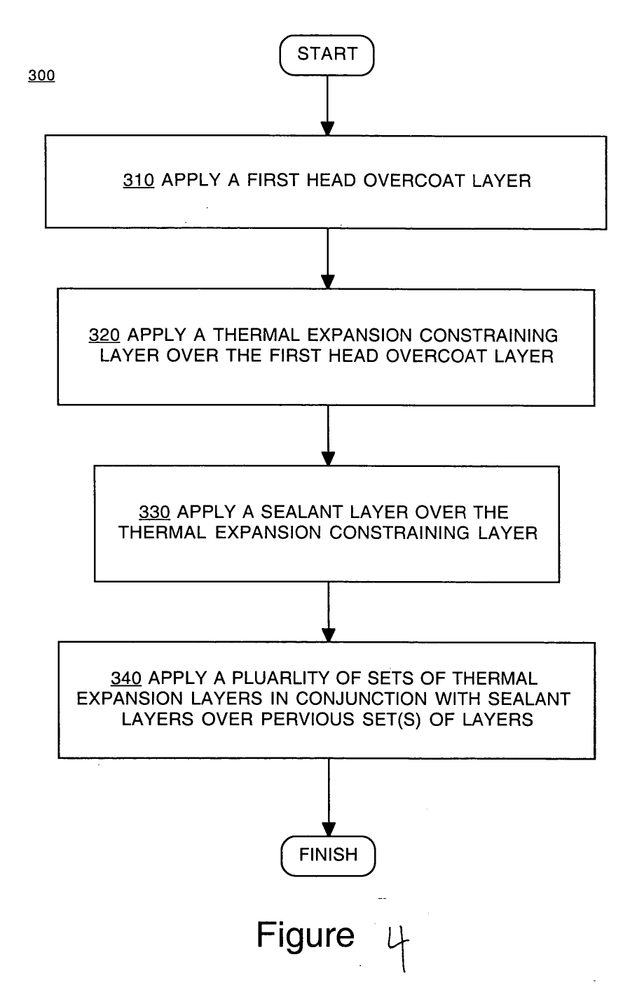

FIG. 4 illustrates an exemplary process 300 of manufacturing a magnetic recording head, in accordance with embodiments of the present invention. In block 310, a first head overcoat layer, e.g., first head overcoat layer 220 of FIG. 2, is applied to a head substrate.

In block 320, a thermal expansion constraining layer, e.g., layer 230 of FIG. 3, is applied over the first head overcoat layer. In block 330, a sealant layer, e.g., sealant layer 340 of FIG. 3, is applied over the thermal expansion constraining layer.

In optional block 340, a plurality of sets of thermal expansion constraining layers in conjunction with sealant layers are applied over previous set(s) of such layers.

Embodiments in accordance with the present invention, magnetic recording head with reduced thermally induced protrusion, are thus described. While the present invention has been described in particular embodiments, it should be appreciated that the present invention should not be construed as limited by such embodiments, but rather construed according to the below claims.

1. A magnetic recording head comprising:
a first surface comprising a first material;
a second material adjacent to said first material; and
wherein said second material comprises a coefficient of thermal expansion less than that of said first material, and wherein said first material acts to reduce propagation of surface defects of said second material.

2. A magnetic recording head according to claim 1 wherein said first material comprises aluminum oxide.

3. A magnetic recording head according to claim 1 wherein said second material comprises silicon dioxide.

4. A magnetic recording head according to claim 3 wherein said first material is aluminum oxide.

5. A magnetic recording head according to claim 1 wherein said second material is comprised substantially of silicon dioxide.

6. A magnetic recording head according to claim 1 wherein said first material comprises molybdenum disilicide.

7. A magnetic recording head according to claim 1 wherein said second material comprises alumina.

8. A magnetic recording head according to claim 1 comprising a layer comprising a recording coil disposed adjacent to said second surface.

9. A magnetic recording head comprising:
a first head overcoat layer;
a thermal expansion constraining layer disposed adjacent to said first head overcoat layer; and
a sealant layer disposed adjacent to said thermal expansion constraining layer, wherein said sealant layer comprises greater shock resistance than said thermal expansion constraining layer.

10. A magnetic recording head according to claim 9 wherein said thermal expansion constraining layer comprises silicon dioxide.

11. A magnetic recording head according to claim 9 wherein said thermal expansion constraining layer is substantially comprised of silicon dioxide.

12. A magnetic recording head according to claim 9 wherein said sealant layer comprises aluminum oxide and acts to reduce propagation of surface defects of said thermal expansion constraining layer.

13. A magnetic recording head according to claim 9 wherein said sealant layer is comprised of substantially aluminum oxide.

14. A magnetic recording head according to claim 9 wherein said thermal expansion constraining layer comprises boron nitride.

15. A magnetic recording head according to claim 9 comprising a layer comprising a recording coil disposed adjacent to said first overcoat layer.

16. A method of manufacturing a magnetic recording head comprising:
applying a first head overcoat layer to a head substrate;
applying a thermal expansion constraining layer over said first head overcoat layer; and
applying a sealant layer over said thermal expansion constraining layer.

17. A method according to claim 16 wherein said sealant layer comprises greater shock resistance than said thermal expansion constraining layer.

18. A method according to claim 16 wherein said thermal expansion constraining layer comprises a coefficient of thermal expansion less than that of said first head overcoat layer.

19. A method according to claim 16 wherein said thermal expansion constraining layer comprises silicon dioxide.

20. A method according to claim 16 wherein said sealant layer comprises aluminum oxide.

21. A method according to claim 16 further comprising applying a plurality of sets of thermal expansion constraining layers in conjunction with sealant layers over said sealant layer, wherein a sealant layer comprises the outermost layer.

22. A magnetic recording head comprising:
coil means for generating a magnetic field for recording data on a magnetic media;
alternating layer means coupled to said coil means, said alternating layer means comprising:
a plurality of coating means for constraining thermal expansion of an underlying layer; and
a plurality of sealant means for protecting said coating means from shock and moisture.
